(19) United States
(12) Patent Application Publication
(10) Pub. No.: US 2016/0192770 A1
(43) Pub. Date: Jul. 7, 2016

(54) 3 In one toothbrush flosser

(71) Applicant: Charles Ray Trent, Kansas City, MO (US)

(72) Inventor: Charles Ray Trent, Kansas City, MO (US)

(21) Appl. No.: 14/545,451

(22) Filed: Apr. 27, 2015

(51) Int. Cl. A46B 15/00; A46B 17/04; A61C 15/04

(52) U.S. Cl. CPC A46B 15/0073; A61C 15/046; A46B 17/04

(57) ABSTRACT

A toothbrush with a brush end, a floss end with a locking device, and a handle with a hollow interior. Within the hollow interior is at least one sleeve, at least one rod configured to matingly engage the at least one bearing sleeve, wherein floss is wrapped around the at least one bearing sleeve, and a floss channel configured to guide the floss from the at least one bearing sleeve to the floss end, wherein the locking device is configured to hold the dental floss across the floss end, and wherein the brush end and the floss end are in communication with the handle.

### BACKGROUND OF THE INVENTION

1. Field of Invention

The present invention relates to the field of dental hygiene and more specifically toothbrushes and flossing devices.

2. Description of Related Art

Personal hygiene includes a daily routine including cleaning and preparation of various body areas. Dental care is one of the most important aspects of the personal hygiene routine which includes brushing teeth and flossing. The majority of people, if they do take the time to brush their teeth, neglect to floss because of the additional time necessary.

Current toothbrushes will have a brush end and may lack any specific component for flossing, or may have a simple pick that is incapable of properly flossing between teeth.

Based on the foregoing, there is a need in the art for a convenient and cost effective device that would allow a user to brush and floss their teeth without having to purchase separate devices or taking unnecessary time to use two or more different devices. A need for a device that will promote better dental hygiene practices for dental care.

### SUMMARY OF THE INVENTION

My invention is a toothbrush with a built in flosser system. It has an adjustable locking device that releases and locks the floss as needed. There's a built in tracking system that allows the user to pull out as much as needed. There's a built in cutting system at the tip of the device that cuts and removes the floss to be discarded with a small amount of pressure.

My invention is an oral hygiene product that is designed to provide a multi purpose dental hygiene product that can be used to brush and floss teeth without having to change instruments. To prevent injury and contamination I've designed one (1) cap that locks into grooves over each end. Their purpose is so the desired end of the device can be used without disturbing the other or cause damage to the device unknowingly.

In an embodiment, a toothbrush has a brush end, a floss end with a locking device, and a handle with a hollow interior. Within the hollow interior is at least one sleeve, at least one rod configured to matingly engage the at least one bearing sleeve, wherein floss is wrapped around the at least one bearing sleeve, and a floss channel configured to guide the floss from the at least one bearing sleeve to the floss end, wherein the locking device is configured to hold the dental floss across the floss end, and wherein the brush end and the floss end are in communication with the handle.

In an embodiment, the toothbrush has a brush end cap and a floss end cap, wherein the brush end cap and the floss end cap, wherein the brush end cap is configured to releasably engage the brush end, and wherein the floss end cap is configured to releasably engage the floss end.

In an embodiment, the toothbrush of claim 1, further comprising a floss cutter to sever the floss after use.

In an embodiment, the toothbrush has at least one peg and at least one peg slot, wherein the at least one peg is configured to releasably engage the at least one peg slot.

In an embodiment, the toothbrush has a first side with at least one peg and a second side with at least one peg slot.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the 3 in 1 toothbrush flosser, according to an embodiment of the present invention;

FIG. 2 is a perspective view of the 3 in 1 toothbrush flosser, according to an embodiment of the present invention;

FIG. 3 is a side elevation view of the 3 in 1 toothbrush flosser, according to an embodiment of the present invention;

FIG. 4 is a plan view of the 3 in 1 toothbrush flosser, according to an embodiment of the present invention.

FIG. 5 is a plan view of the 3 in 1 toothbrush flosser, according to an embodiment of the present invention;

FIG. 6 is a perspective view of the 3 in 1 toothbrush flosser, according to an embodiment of the present invention;

### DETAILED DESCRIPTION OF PREFERRED EMBODIMENTS

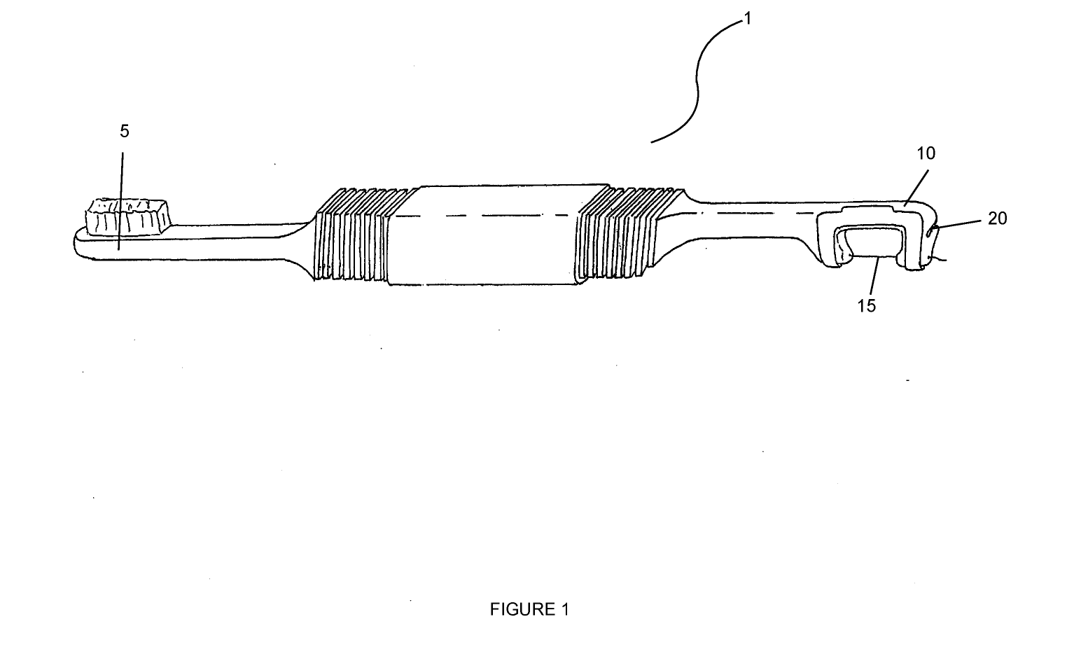

Preferred embodiments of the present invention and their advantages may be understood by referring to FIGS. 1-5, wherein like reference numerals refer to like elements.

A three in one toothbrush flosser 1 has a brush end 5 and a flosser end 10. In FIG. 1, the toothbrush is shown in the closed position with floss extending outward from the body of the toothbrush towards the distal portion of the flosser end. A floss cutter 20 is also shown in the flosser end 10 and the floss cutter is able to cut a section of the floss off.

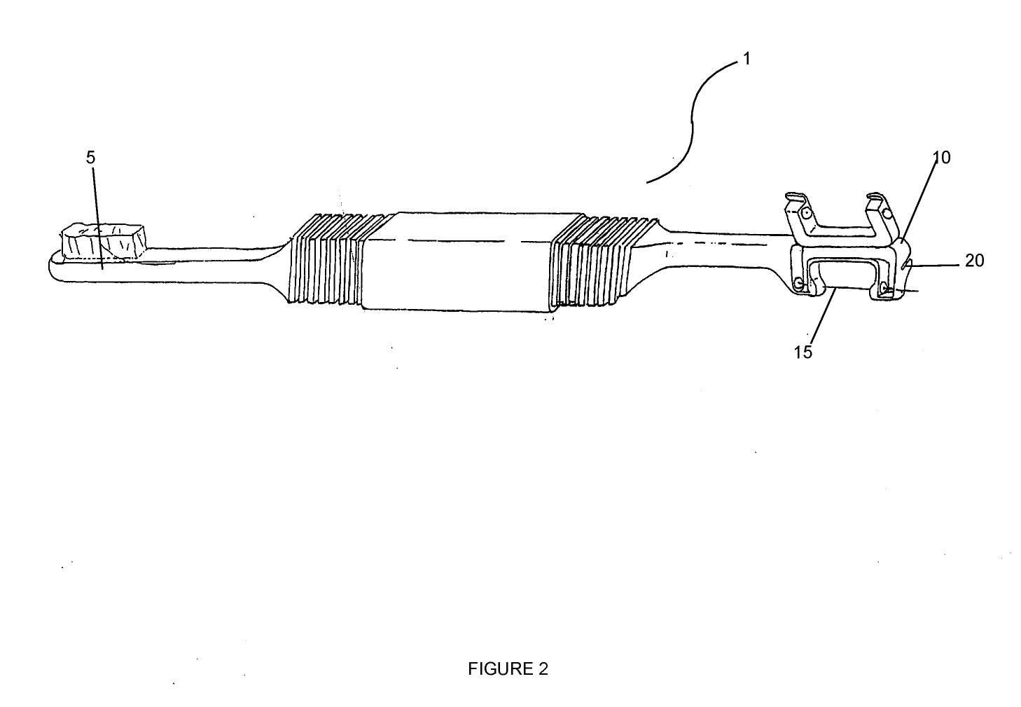

In an embodiment, FIG. 2 illustrates the three is one toothbrush 1, in an open position, where the floss end 10 is opened allowing for a user to pull floss 15 through the floss end 10. The floss 15 is pulled through the floss end 10 and can be cut by the floss cutter 20.

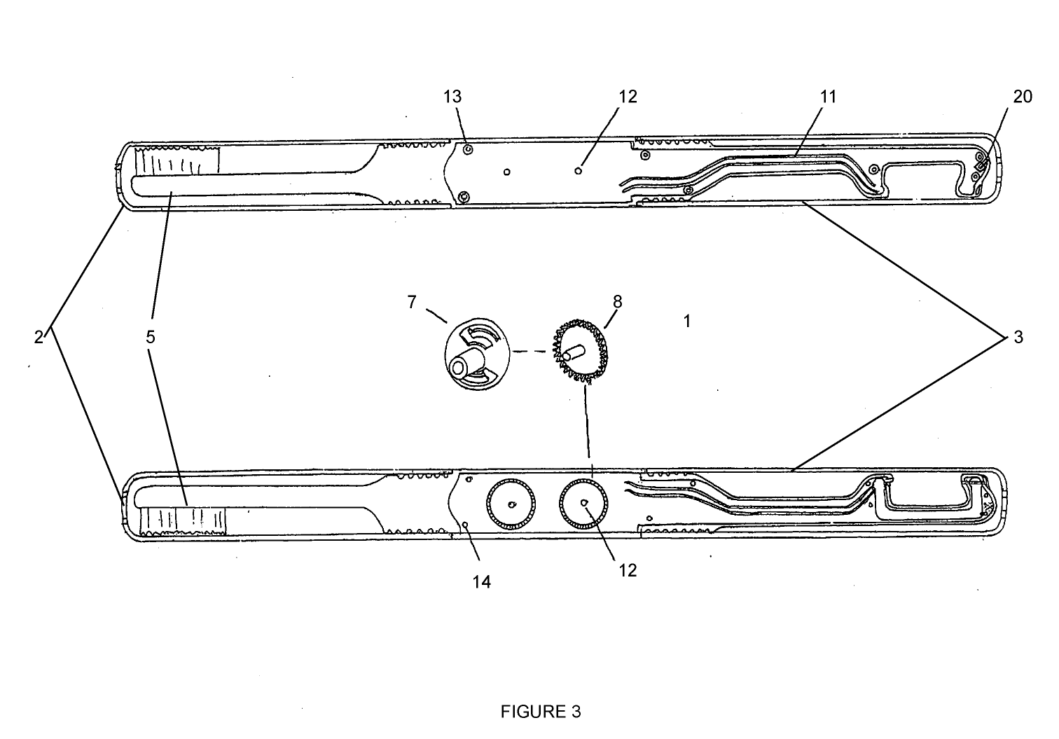

In an embodiment, the three in one toothbrush 1 has a brush cap 2 configured to matingly engage the brush end 5 and a floss end cap 3 configured to accept the floss end. FIG. 3 shows the three in one toothbrush 1 in a separated position where the toothbrush is able to be opened by separating both halves. Inside the toothbrush, is at least one peg 14 and at least one peg slot 13 where the peg slot is configured to matingly engage with the peg 14. A floss channel 11 is shown as directing the path the floss travels through the toothbush towards the floss end. The floss channel 11 is a track molded into product which dental floss guides through. One or more rods 12 are shown for bearing sleeves 16 to ride on. A blade is inserted to allow cutting of dental floss at the floss cutter 20. Male type Pegs 14 to close a side of product. Female type peg slots are configured to the male pegs 14 to close together both sides of product. In an alternative embodiment, a first floss wheel 7 and second floss wheel 8 are shown to hold and control the floss roll inside the toothbrush.

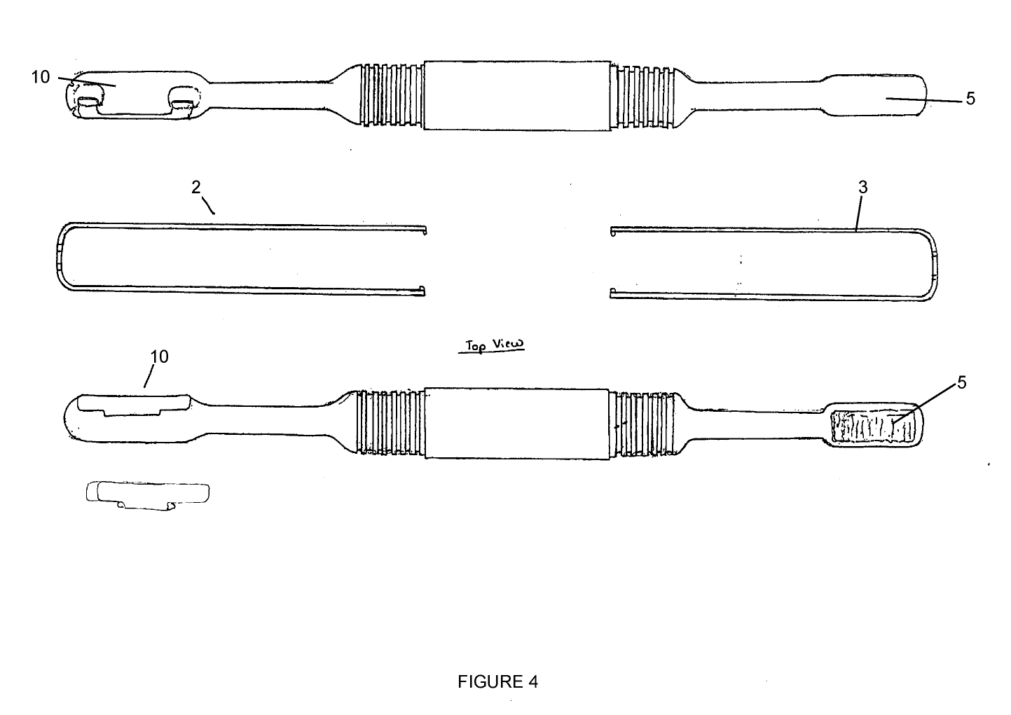

FIG. 4 shows an outer view of the top and bottom of the toothbrush. Lids 2 and 3 for ends 10 and 5, respectively, of product, also function as a handle when closed. Locking piece 19 for Dental flosser for product, when closed locks string in place.

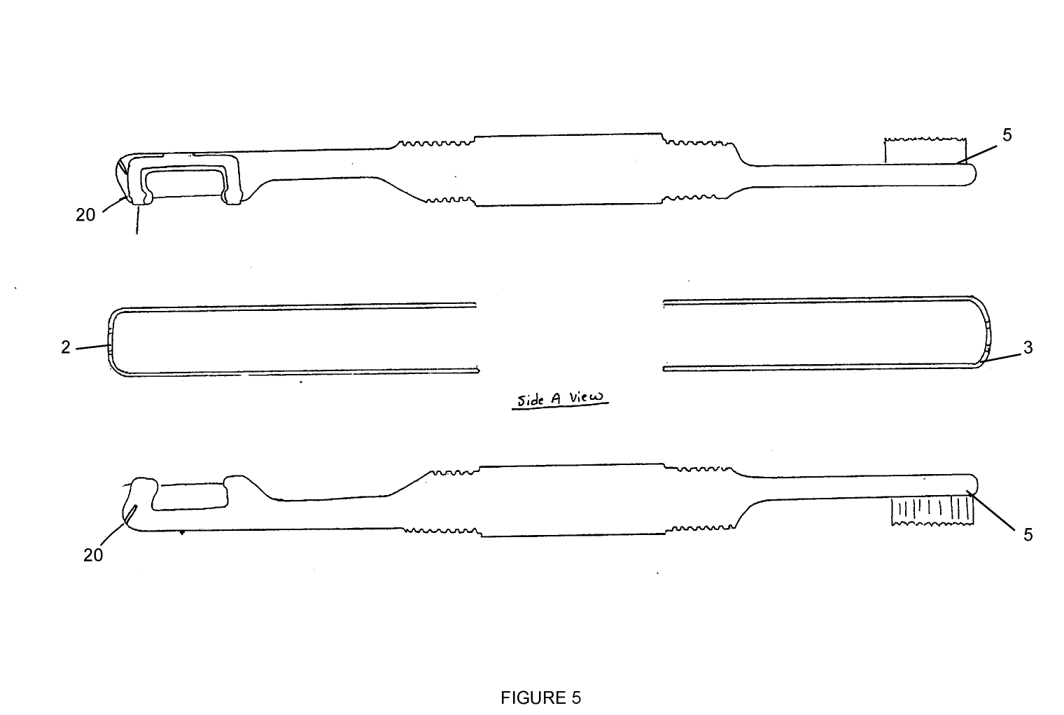

FIG. 5 shows an outer view side angle having a dental floss cutter 20 and locking piece 19 for dental flosser section locks the floss in place at the floss end 10. Locking piece module 19, designed to fit into main product, snaps into locking position also pinning Dental floss string into place preventing it from moving. Caps 2 and 3 are also shown to cover the brush end 5 and the floss end.

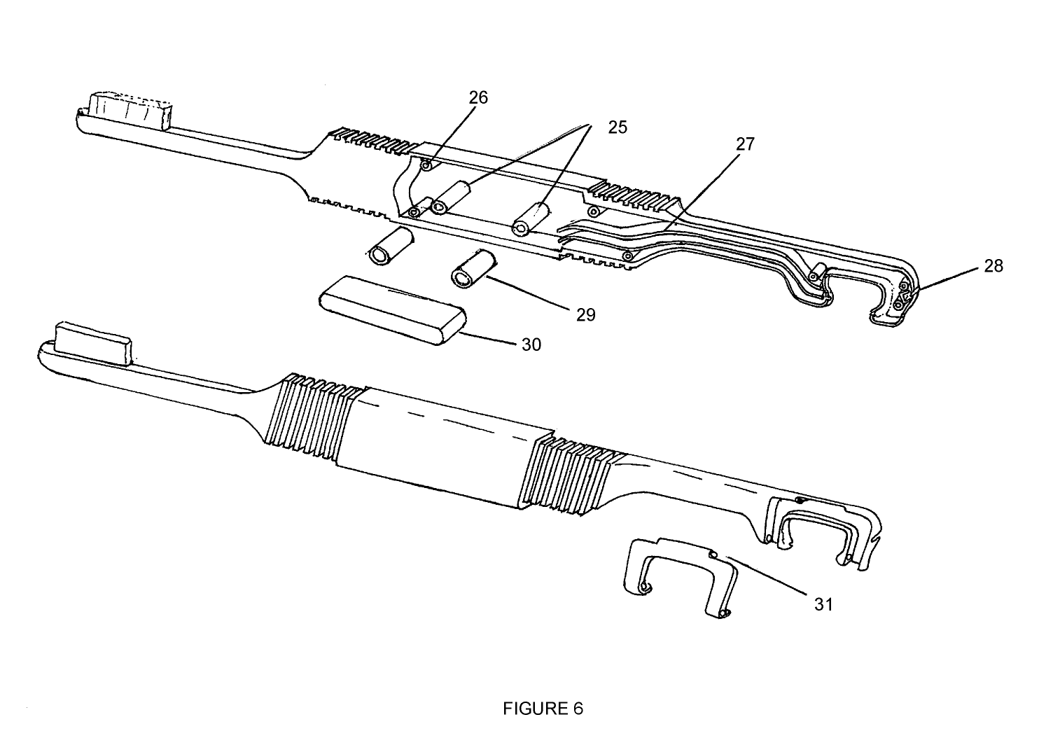

FIG. 6 shows a detailed view of interior of the toothbrush. One or more rods 25 accept bearing sleeves 29 for dental floss ribbon 30 to fit over and spin. Ribbon 30 that dental floss is wrapped around and un-spooled from. Track 27 for dental floss to run through. Rods 25 for bearing sleeves 29 and dental floss to sit on. Where Dental floss cutting blade 28 is fitted into the floss end. Female slat 26 are configured for male pegs (not shown) to close together both sides of product. Dental floss locking mechanism 31 showing how designed to snap on to toothbrush itself.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A toothbrush comprising:
a. a brush end;
b. a floss end having a locking device,
c. a handle having a hollow interior, the hollow interior comprising:
i. at least one sleeve;
ii. at least one rod configured to matingly engage the at least one bearing sleeve, wherein dental floss is wrapped around the at least one bearing sleeve;
iii. a floss channel configured to guide the dental floss from the at least one bearing sleeve to the floss end,
wherein the locking device is configured to hold the dental floss across the floss end, and wherein the brush end and the floss end are in communication with the handle.

2. The toothbrush of claim 1, further comprising a brush end cap and a floss end cap, wherein the brush end cap and the floss end cap, wherein the brush end cap is configured to releasably engage the brush end, and wherein the floss end cap is configured to releasably engage the floss end.

3. The toothbrush of claim 1, further comprising a floss cutter configured to sever the dental floss.

4. The toothbrush of claim 1, further comprising at least one peg and at least one peg slot, wherein the at least one peg is configured to releasably engage the at least one peg slot.

5. The toothbrush of claim 1, further comprising a first side having at least one peg and a second side having at least one peg slot.
